(19) United States
(12) Patent Application Publication
(10) Pub. No.: US 2015/0229398 A1
(43) Pub. Date: Aug. 13, 2015

(54) LINK ACTIVATION METHOD AND APPARATUS FOR PROTECTION PATH

(71) Applicant: Electronics and Telecommunications Research Institute, Daejeon (KR)

(72) Inventors: Jong Seok LEE, Daejeon (KR); Dae Ub KIM, Daejeon (KR); Sun Me KIM, Daejeon (KR); Tae Il KIM, Daejeon (KR); Jong Hyun LEE, Daejeon (KR)

(21) Appl. No.: 14/620,687

(22) Filed: Feb. 12, 2015

(30) Foreign Application Priority Data
Feb. 12, 2014 (KR) 10-2014-0015901

(51) Int. Cl. H04B 10/27; H04L 12/24

(52) U.S. Cl. CPC H04B 10/27; H04L 41/12; H04L 41/0681

(57) ABSTRACT

Provided is a method and apparatus for activating a link between a first node and a second node for transmission of a lower order optical channel data unit (ODU), in which the link may be activated based on a first adaptation function between a higher order ODU and the lower order ODU performed by the second node and a second adaption function between the higher order ODU and the lower order ODU performed by the first node, and may also be activated when the first node receives an activation message from a third node, a preceding node of the first node.

### CROSS-REFERENCE TO RELATED APPLICATION

This application claims the priority benefit of Korean Patent Application No. 10-2014-0015901, filed on Feb. 12, 2014, in the Korean Intellectual Property Office, the disclosure of which is incorporated herein by reference.

### BACKGROUND

1. Field of the Invention

Embodiments of the present invention relate to technology for activating a link between two nodes, and more particularly, to a link activation method and apparatus for a protection path.

2. Description of the Related Art

A protection path may be set to prepare for an error occurring in a main path through which a packet is transmitted. When the packet is transmitted normally through the main path, the protection path may not be activated. However, when an error occurs in the main path, a transmission path of the packet may be changed from the main path to the protection path. To change the transmission path, the protection path may be activated in advance. A multiplexing structure of a higher layer of the protection path may be set for a link between two successive nodes among nodes included in the protection path.

### SUMMARY

An aspect of the present invention provides a method and apparatus for activating a link between two nodes.

Another aspect of the present invention also provides a link activation method and apparatus for a protection node.

According to an aspect of the present invention, there is provided a link activation method performed by a first node, the method including receiving, from a third node, a first activation message requesting activation of a first link between the first node and a second node for transmission of a lower order optical channel data unit (ODU), transmitting, in response to the first activation message, to the second node, an adaptation request message requesting a first adaptation function be performed between a higher order ODU and the lower order ODU, receiving, from the second node, a response message responding to a request for the first adaptation function, performing, when the first adaptation function is performed, a second adaptation function between the higher order ODU and the lower order ODU, and activating the first link by generating a cross connection (XC) between the first node and the second node based on the first adaptation function and the second adaptation function.

The link activation method may further include transmitting, to the second node, a second activation message requesting activation of a second link between the second node and a fourth node for transmission of the lower order ODU.

The performing may include determining whether resources of the first node for use in the second adaptation function are present.

The performing may include performing the second adaptation function using the resources of the first node for use in the second adaptation function when the resources are determined to be present.

The performing may further include determining whether the resources are predetermined resources for use in an adaptation function between the higher order ODU and the lower order ODU.

The performing may include performing the second adaptation function between the higher order ODU and the lower order ODU based on information associated with the predetermined resources when the resources are the predetermined resources.

The link activation method may further include transmitting, to the second node, a second activation message requesting activation of a second link between the second node and a fourth node for transmission of the lower order ODU.

The second activation message may include the information associated with the predetermined resources.

The information of the predetermined resources may be indicated in an automatic protection switching coordination channel and protection communication control channel (APS and PCC) field of the second activation message.

The performing may further include determining whether the resources are predetermined resources for use in an adaptation function between the higher order ODU and the lower order ODU.

The performing may include performing, when the resources are not the predetermined resources, the second adaptation function between the higher order ODU and the lower order ODU based on information associated with the resources.

The link activation method may further include transmitting, to the second node, a second activation message requesting activation of a second link between the second node and a fourth node for transmission of the lower order ODU.

The second activation message may include the information associated with the second activation message.

The information associated with the resources may be indicated in an APS and PCC field of the second activation message.

The link activation method may further include transmitting a failure message indicating a failure in activating the first link to the third node when the second adaptation function is not performed.

The link activation method may further include transmitting, to the second node, a second activation message requesting activation of a second link between the second node and a fourth node for use in transmission of the lower order ODU.

The second activation message may include adaptation information of the performed second adaptation function.

The adaptation information may be indicated in a reserved field of the second activation message.

The information associated with the second adaptation function may include at least one of content of a request from the first node, a type of an interface set to the first node, a port number (PN) of a tributary slot (TS) for use in the second adaptation function, and an ODU trail identifier.

The type of the interface set to the first node may correspond to one of internal-network to network interface (I-NNI) types.

The information associated with the second adaptation function may include a type of an interface set to the first node.

The information associated with the second adaptation function may indicate whether the interface has a type accepting ODU multiplexing of at least two levels of data.

According to another aspect of the present invention, there is also provided a node including, the node being a first node, a communicator to receive, from a third node, a first activation message requesting activation of a first link between the first node and a second node for transmission of a lower order ODU, transmit, to the second node, in response to the first activation message, an adaptation request message requesting a first adaptation function be performed between a higher order ODU and the lower order ODU, and receive, from the second node, a response message responding to a request for the first adaptation function, and a processor to perform, when the first adaptation function is performed, a second adaptation function between the higher order ODU and the lower order ODU, and activate the first link by generating an XC between the first node and the second node based on the first adaptation function and the second adaptation function.

The communicator may transmit, to the second node, a second activation message requesting activation of a second link between the second node and a fourth node for transmission of the lower order ODU. The processor may determine whether resources of the first node for use in the second adaptation function are present, and perform the second adaptation function using the resources of the first node for use in the second adaptation function when the resources are determined to be present.

The communicator may transmit, to the second node, a second activation message requesting activation of a second link between the second node and a fourth node for transmission of the lower order ODU.

The second activation message may include the information associated with the performed second adaptation function.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a hierarchy of an optical transport network (OTN) according to an example embodiment;

FIGS. 2 through 5 illustrate data in an OTN according to an example embodiment;

FIG. 6 illustrates a configuration of an optical channel data unit k (ODUk) frame according to an example embodiment;

FIG. 7 illustrates an ODUk overhead and an optical channel load payload unit k (OPUk) overhead according to an example embodiment;

FIG. 8 illustrates a path monitoring (PM) field or a tandem connection monitoring (TCM) field according to an example embodiment;

FIG. 9 illustrates a PM and TCM field according to an example embodiment;

FIG. 10 illustrates an OPUk overhead according to an example embodiment;

FIG. 11 illustrates an internal-network to network interface (I-NNI) type-1 according to an example embodiment;

FIG. 12 illustrates an I-NNI type-2 according to an example embodiment;

FIG. 13 illustrates an I-NNI type-3 according to an example embodiment;

FIG. 14 illustrates a shared mesh network included in a network according to an example embodiment;

FIG. 15 illustrates an activated first protection path according to an example embodiment;

FIG. 16 illustrates a configuration of a node according to an example embodiment;

FIG. 17 illustrates an example of a signal flow in a link activation method according to an example embodiment;

FIG. 18 illustrates a method of performing a second adaptation function according to an example embodiment; and

FIG. 19 illustrates a revised reserved field according to an example embodiment.

### DETAILED DESCRIPTION

Hereinafter, exemplary embodiments will be described in detail with reference to the accompanying drawings, wherein like reference numerals refer to like elements throughout.

Various alterations and modifications may be made to the exemplary embodiments, some of which will be illustrated in detail in the drawings and detailed description. However, it should be understood that these embodiments are not construed as limited to the illustrated forms and include all changes, equivalents or alternatives within the idea and the technical scope of this disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “include” and/or “have,” when used in this specification, specify the presence of stated features, integers, steps, operations, elements, components or combinations thereof, but do not preclude the presence or addition of one or more other features, integers, steps, operations, elements, components, and/or groups thereof.

Unless otherwise defined, all terms including technical and scientific terms used to herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Like reference numerals in the drawings denote like elements, and redundant descriptions of like elements will be omitted herein. When it is determined a detailed description of a related known function or configuration they may make the purpose of the present invention unnecessarily ambiguous in describing the present invention, the detailed description will be omitted herein.

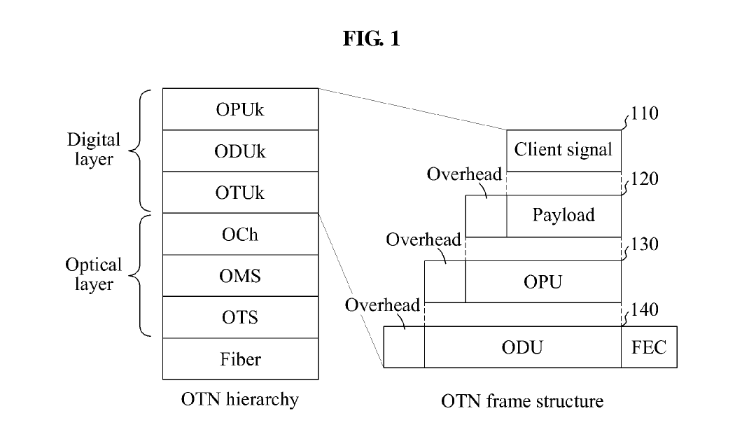

FIG. 1 illustrates a hierarchy of an optical transport network (OTN) according to an example embodiment.

The OTN may refer to an optical transport method standardized by the International Telecommunications Union, and define an optical transport hierarchy (OTH) supporting an optical network operation and management.

The hierarchy of the OTN may include an optical layer.

The optical later may include an optical channel (OCh) layer, an optical multiplex section (OMS) layer, and an optical transmission section (OTS) layer.

The OCh layer may include a digital layer.

The digital layer may include an optical channel transport unit k (OTUk), an optical channel data unit k (ODUk), and an optical channel payload unit k (OPUk).

In the OTUk, the ODUk, and the OPUk, k denotes an integer, for example, “1”, “2”, “3”, and “4”, each defined based on an industry standard. “1” may indicate a transmission rate of 1.25 gigabytes (GB). “2” may indicate a transmission speed of 10 GB. “3” may indicate a transmission speed of 40 GB. “4” may indicate a transmission speed of 100 GB.

A client signal 110 may correspond to a payload of an OPUk frame 120.

The OPUk frame 120 may be included in an ODUk frame 130.

The ODUk frame 130 may be included in an OTUk frame 140. The OTUk frame 140 may include a forwarding error correction (FEC). The FEC may be used to detect an error occurring in a process of transmitting the OTUk frame 140.

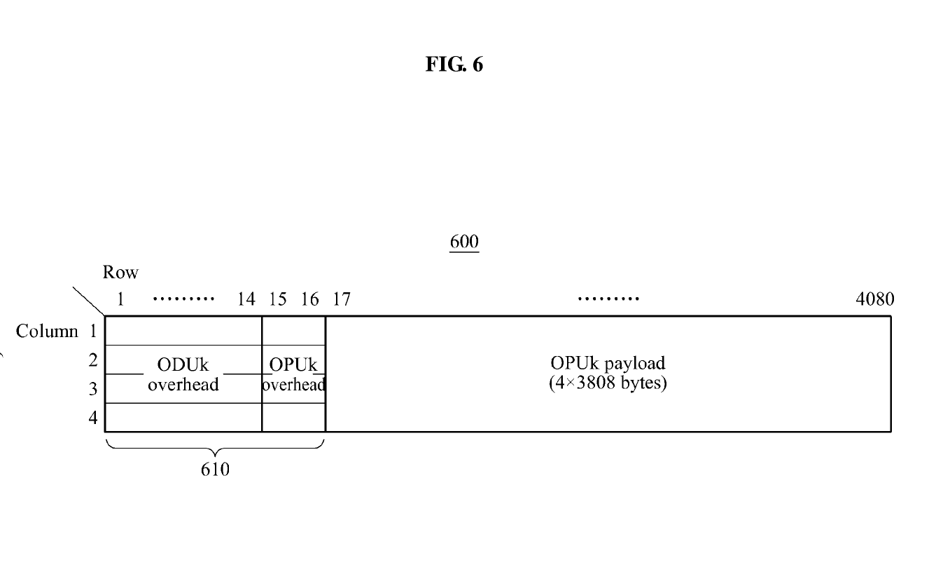

Descriptions about a configuration of the ODUk frame 130 will be provided with reference to FIGS. 6 through 10.

The OTN may be a multi-service transfer network supporting various services. The OTN may support various client signals including the client signal 110 in a transfer network. For example, the client signal 110 may include a video, a data center, and a storage networking.

The OTN may have flexibility for accepting a varying bandwidth granularity. The client signal 110 may adopt a type in which a single transfer layer is used. The OTN may interwork with a network of another provider.

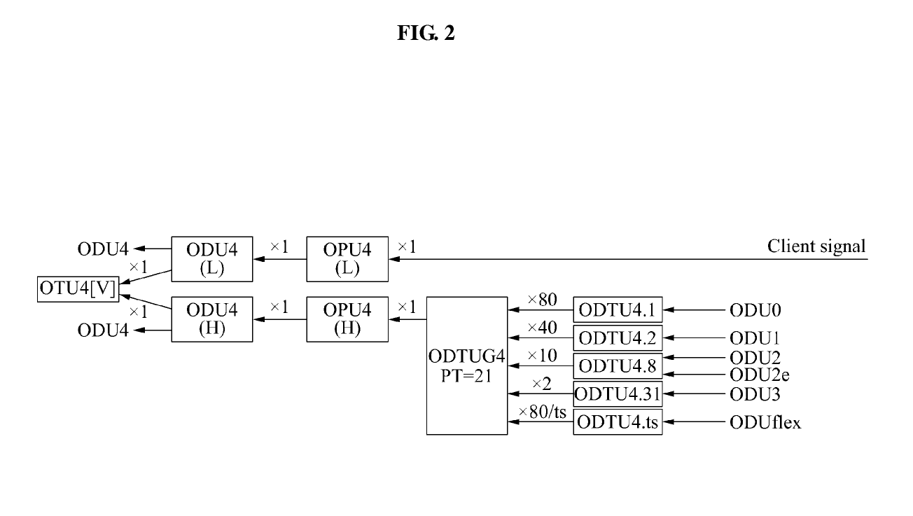

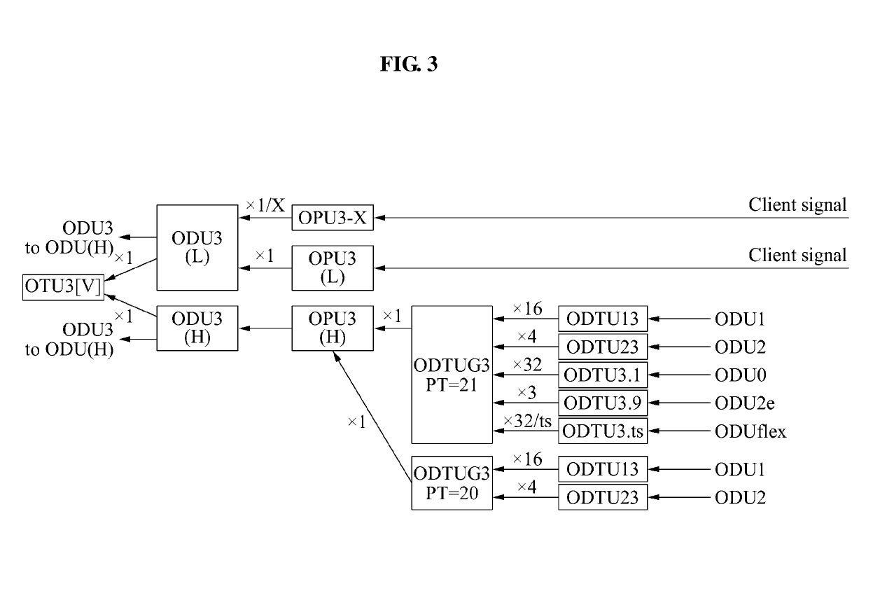

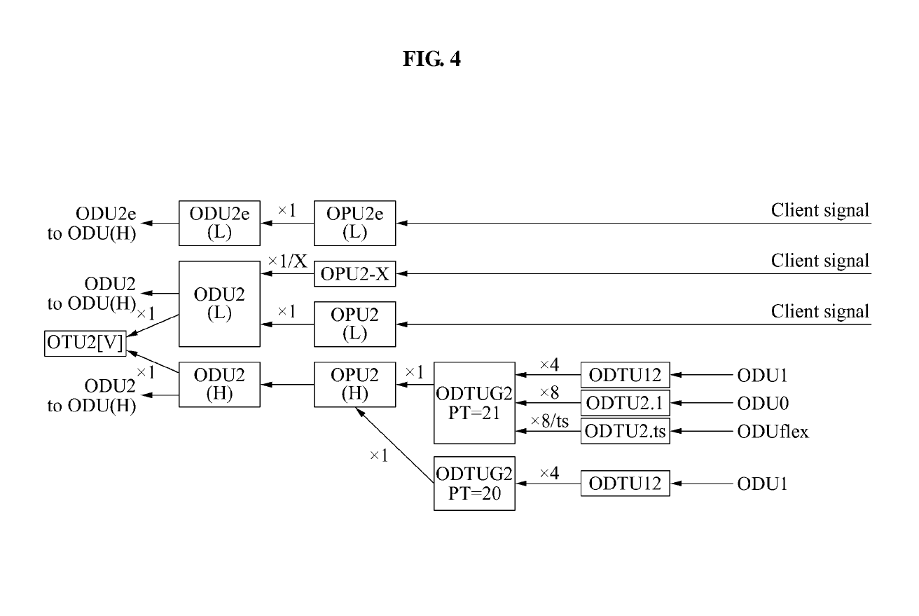

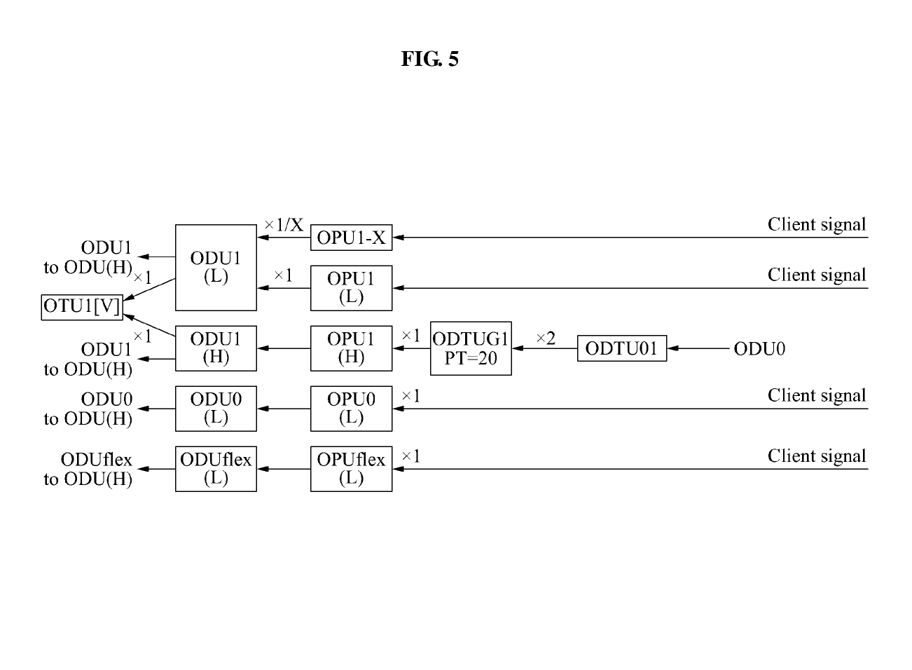

The OTN may configure an optical data layer including various layers by accepting various ODU digital signals and a predetermined client signal, for example, the client signal 110. Hereinafter, descriptions about an example in which the OTN corresponding to an infrastructure of a fiber-optic based transport network configures an optical data layer having various layers will be provided with reference to FIGS. 2 through 5.

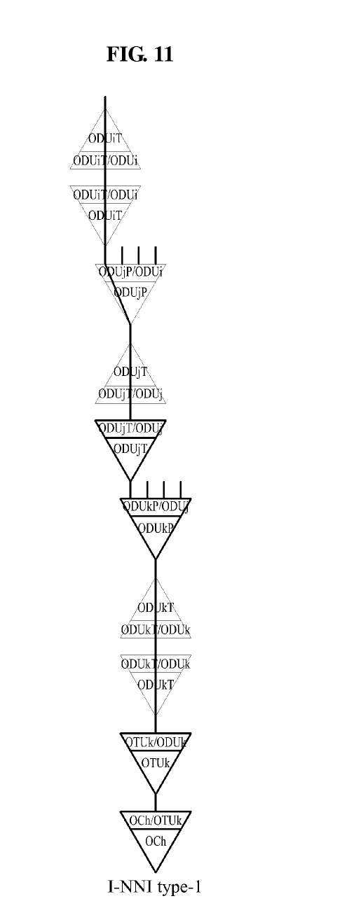

An interface may be supported to configure the optical data layer having various layers in an OTN shared mesh protection (SMP) network. Descriptions about the supported interface will be provided with reference to FIGS. 11 through 13.

FIGS. 2 through 5 illustrate data accepted in an OTN according to an example embodiment.

Referring to FIGS. 2 through 5, the OTN may accept various signals. For example, at least one of ODUO, ODU1, OUD2, ODU2e, ODU3, ODUflex, and a client signal may correspond to the various signals.

FIG. 6 illustrates a configuration of an ODUk frame 600 according to an example embodiment.

The ODUk frame 600 may correspond to the ODUk frame 130 of FIG. 1.

The ODUk Frame 600 may be an ODUk frame defined by the International Telecommunication Union Telecommunication Standardization Sector (ITU-T) G.709.

The ODUk frame 600 may include an ODUk overhead and an OPUk overhead (ODUk overhead/OPUk overhead) 610, and an OPUk payload.

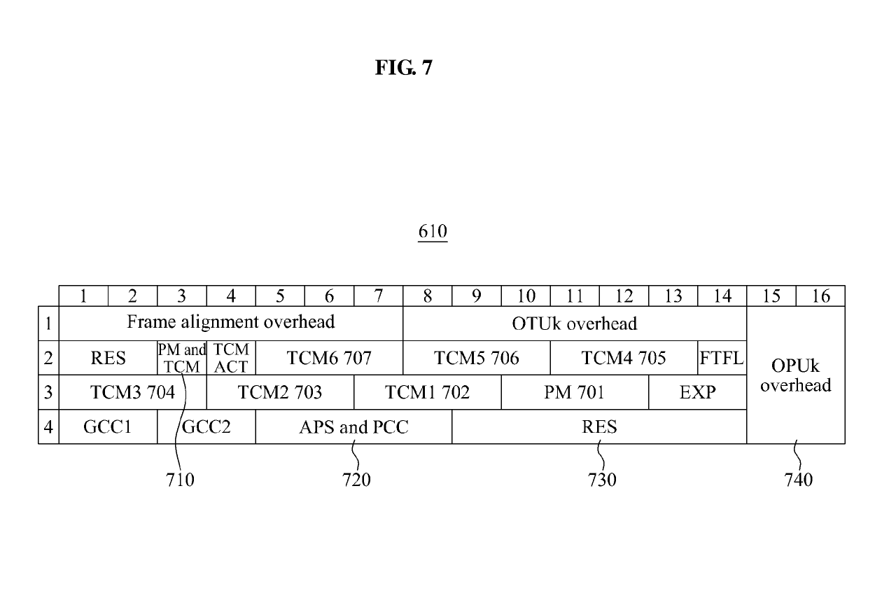

Hereinafter, descriptions about the ODUk overhead/OPUk overhead 610 will be provided with reference to FIG. 7.

FIG. 7 illustrates the ODUk overhead/OPUk overhead 610 of FIG. 6.

Fields included in the ODUk overhead of the ODUk overhead/OPUk overhead 610 may be indicated in Table 1.

TABLE 1

| Name | Function |
|---|---|
| Frame alignment | Field for aligning an order among frames |
| overhead | |
| RES | Reserved (RES) field |
| PM and TCM | Path monitoring (PM) and tandem connection |
| | monitoring (TCM) field |
| TCM ACT | Tandem connection monitoring (TCM) activation |
| | or deactivation control channel (ACT) field |
| TCM1 | Tandem connection monitoring (TCM) 1 field |
| TCM2 | Tandem connection monitoring (TCM) 2 field |
| TCM3 | Tandem connection monitoring (TCM) 3 field |
| TCM4 | Tandem connection monitoring (TCM) 4 field |
| TCM5 | Tandem connection monitoring (TCM) 5 field |
| TCM6 | Tandem connection monitoring (TCM) 6 field |
| FTFL | Fault type and fault location reporting |
| | channel (FTFL) |
| EXP | Experimental (EXP) field |
| GCC1 | General communication channel (GCC) 1 |
| GCC2 | General communication channel (GCC) 2 |
| APS and PCC | Automatic Protection Switching coordination |
| | channel (APS) and protection communication |
| | control channel (PCC) |
| PM | Path monitoring (PM) |

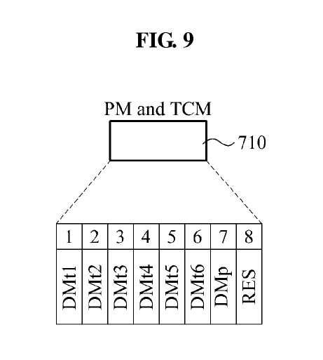

Descriptions about a PM and TCM 710 will be provided with reference to FIG. 9.

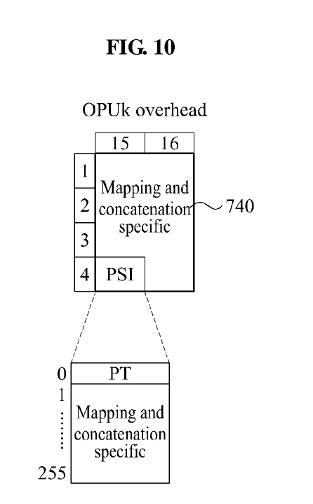

Descriptions about an OPUk overhead 740 will be provided with reference to FIG. 10.

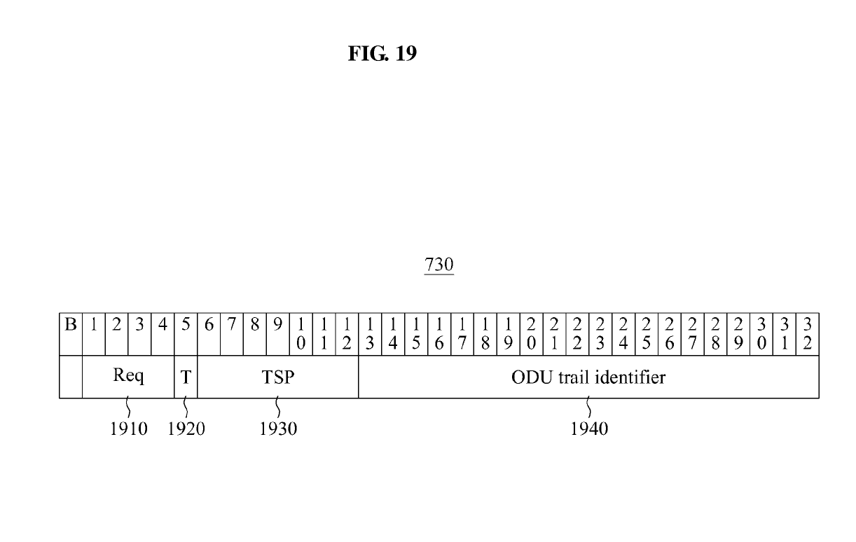

Descriptions about an RES 730 will be provided with reference to FIG. 19.

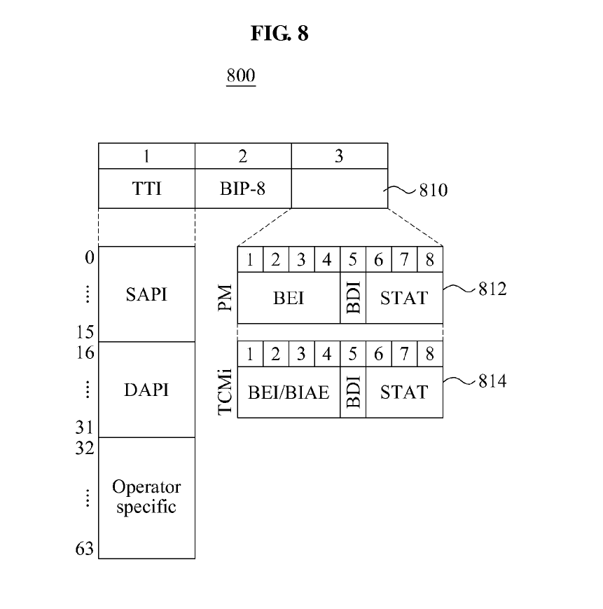

Hereinafter, descriptions about a PM 701, a TCM1 702, a TCM2 703, a TCM3 704, a TCM4 705, a TCM5 706, and a TCM6 707 will be provided with reference to FIG. 8.

FIG. 8 illustrates a PM field or a TCM field according to an example embodiment.

When a field 800 is the PM 701, a third byte 810 of the field 800 may be a first field 812.

When the field 800 is one of the TCM1 702, the TCM2 703, the TCM3 704, the TCM4 705, the TCM5 706, and the TCM6 707, the third byte 810 of the field 800 may be a second field 814.

Fields included in the field 800 may be indicated in Table 2.

TABLE 2

| Name | Function |
|---|---|
| TTI | Trail trace identifier (TTI) |
| BIP-8 | Bit interleaved parity-level 8 (BIP-8) |
| SAPI | Source access point identifier (SAPI) |
| DAPI | Destination access point identifier (DAPI) |
| Operator specific | Operator specific |
| BEI | Backward error indication (BEI) |
| BDI | Backward defect indication (BDI) |
| STAT | Status (STAT) |
| BIAE | Backward incoming alignment error (BIAE) |

The field 800 may include a TTI and a BIP-8. The field 800 may include the first field 812 or the second field 814.

The TTI may include at least one of an SAPI, a DAPI, and an Operator specific.

FIG. 9 illustrates a PM and TCM field according to an example embodiment.

The aforementioned PM and TCM 710 may include an RES field and a field related to a delay measurement (DM). The field related to the DM may be provided in plural.

FIG. 10 illustrates an OPUk overhead according to an example embodiment.

The aforementioned OPUk overhead 740 may include at least one of a mapping and concatenation specific field and a payload structure identifier (PSI).

FIG. 11 illustrates an internal-network to network interface (I-NNI) type-1 according to an example embodiment.

An OTN interface among OTN interfaces supported in an ODU SMP network may be indicated with reference to FIG. 11. The interface of FIG. 11 may correspond to the I-NNI type-1.

The I-NNI type-1 may correspond to an interface accepting a lower hierarchical ODU as a higher hierarchical ODUk. For example, the lower hierarchical ODU may be an ODUj, j being an integer. In terms of the ODUj accepted to an ODUk, a value of k may be greater than a value of j.

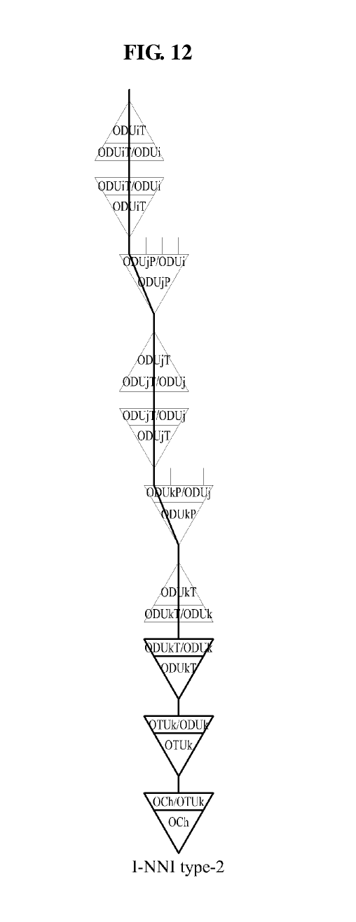

FIG. 12 illustrates an I-NNI type-2 according to an example embodiment.

An OTN interface among OTN interfaces supported in an ODU SMP network may be indicated with reference to FIG. 12. The interface of FIG. 12 may correspond to the I-NNI type-2.

The I-NNI type-2 may be used to directly connect an ODU to a wavelength by incorporating the ODU in an OTUk signal irrespective of an ODU hierarchy.

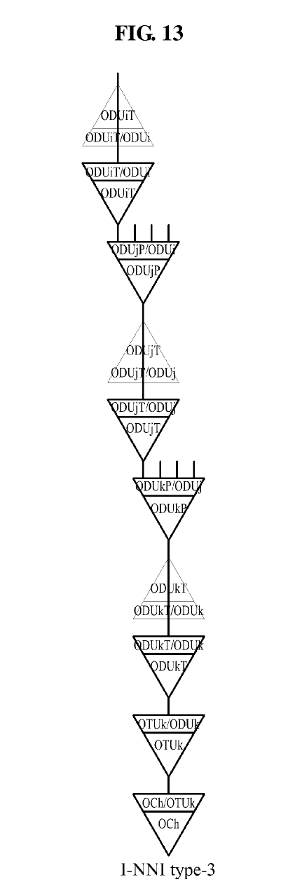

FIG. 13 illustrates an I-NNI type-3 according to an example embodiment.

An OTN interface among OTN interfaces supported in an ODU SMP network may be indicated with reference to FIG. 13. The interface of FIG. 13 may correspond to the I-NNI type-3.

The I-NNI type-3 may accept ODU multiplexing of at least two levels of data. In a link using the I-NNI type-3, performing an ODU adaptation between an ODUk and an ODUj may be necessary to transmit an ODU signal.

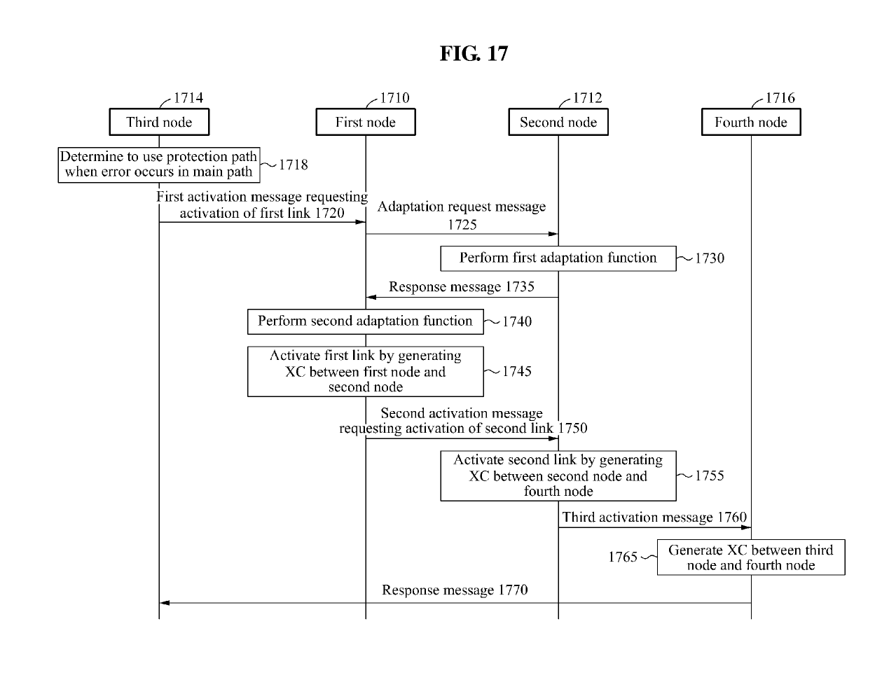

Descriptions about the adaptation will be provided with reference to FIGS. 17 through 19.

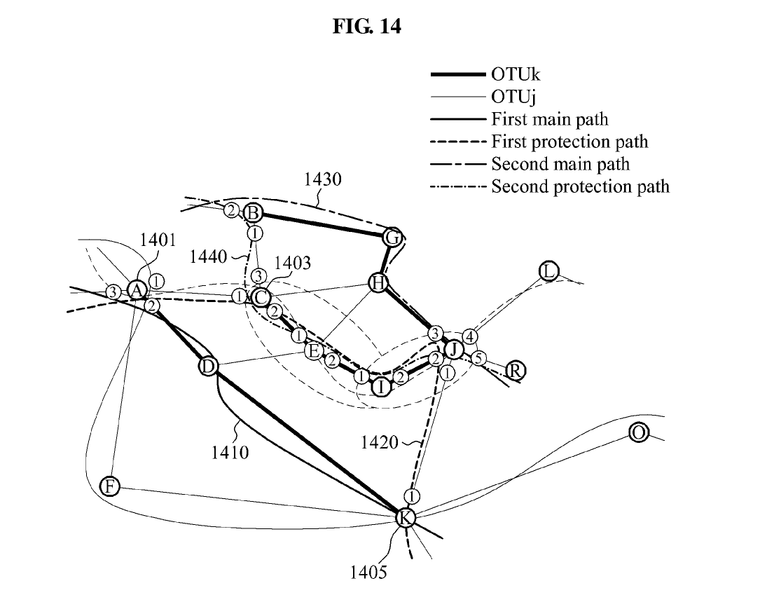

FIG. 14 illustrates a shared mesh network included in a network according to an example embodiment.

A first main path 1410 may be a transfer path including a node A 1410, a node D, and a node K 1405. A first ODU trail may be transmitted through the first main path 1410. The first ODU trail may correspond to data associated with a first user.

A first protection path 1420 corresponding to a protection path of the first main path 1410 may be a transfer path including the node A 1401, a node C 1403, a node E, a node I, a node J, and the node K 1405. On the first protection path 1420, the node A 1401 may be an ingress node. The node C, the node E, the node I, and the node J may be intermediate nodes. The node K 1405 may be an egress node.

A second main path 1430 may be a transfer path including a node B, a node G, a node H, and the node J. A second ODU trail may be transmitted through the second main path 1430. The second ODU trail may correspond to data associated with a second user.

A second protection path 1440 corresponding to a protection path of the second main path 1430 may be a transfer path including the node B, the node C 1403, the node E, the node I, and the node J.

A link between the node A 1401 and the node D may be a link through which an OTUk is transmitted.

A link between the node A 1401 and the node C 1403 may be a link through which an OTUj is transmitted. In a case in which the ODUk corresponds to a high order, the ODUj may correspond to a low order of the OTUk multiplexed when the ODUk is multiplexed.

The first main path 1410 may be in an activated state. When an ODU is transmitted through the first main path 1410, the first protection path 1420 may be in an inactivated state. For example, resources for use in the first protection path 1420 may not be allocated for each node included in the first protection path 1420.

A node may allocate resources of the node based on profile information set to the node. When simultaneous requests are received by the node for generating two paths, the node may allocate the resources to a path having a higher priority based on an order of priority.

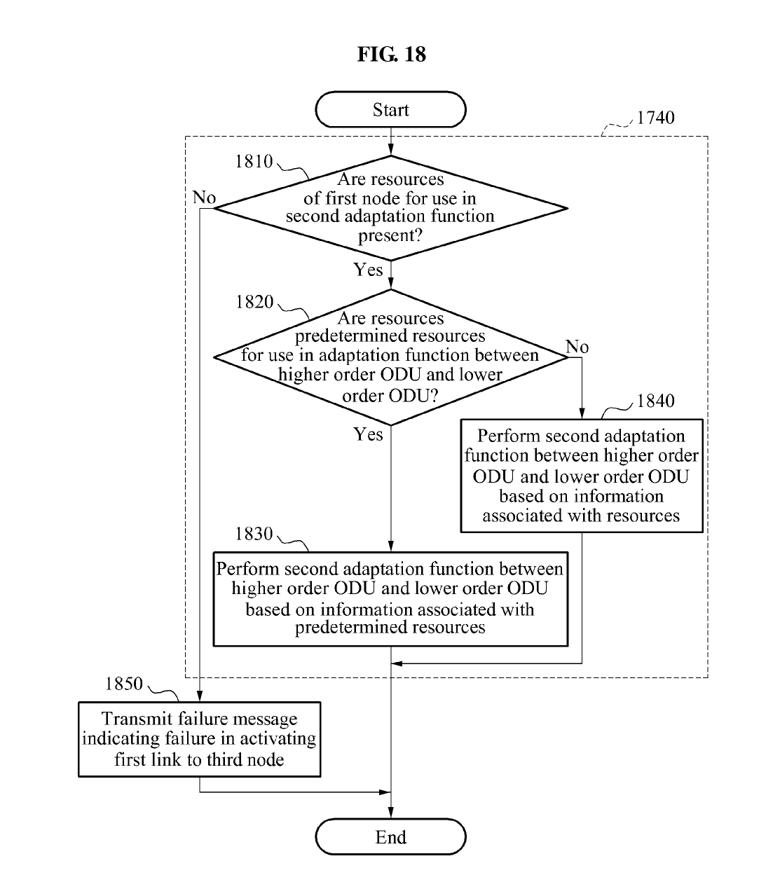

Descriptions about the profile information set to the node will be provided with reference to FIG. 18.

Numerals indicated around the node may denote a port number (PN) of a tributary slot (TS) of the node.

When the ODU is not to be transmitted due to an error occurring in the first main path 1410, the ODU may be transmitted through the first protection path 1420. To transmit the ODU through the first protection path 1420, the first protection path 1420 may need to be activated. When the first protection path 1420 is activated, an ODU multiplexing structure of a higher layer may need to be reconfigured based on an I-NNI used in an OTN.

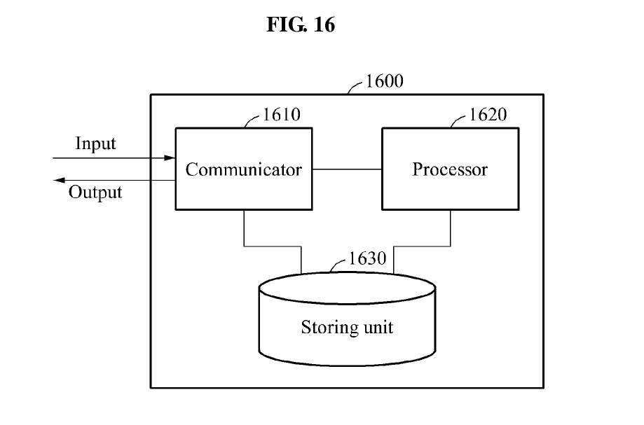

Descriptions about a method of activating the first protection path 1420 will be provided with reference to FIGS. 16 through 19.

Descriptions provided with reference to FIGS. 1 through 13 may be identically applied and thus, repeated descriptions will be omitted for increased clarity and conciseness.

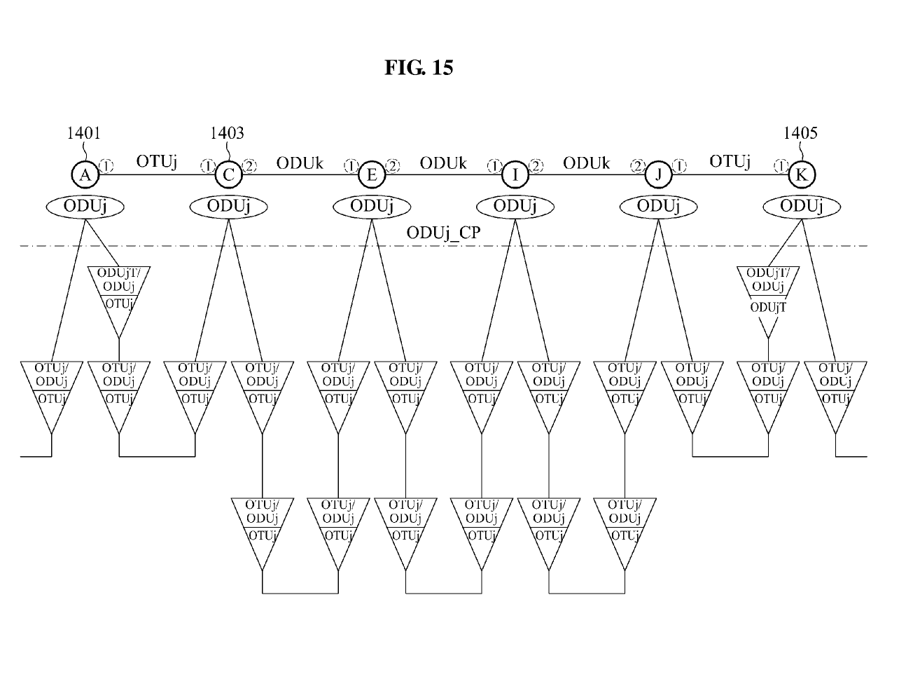

FIG. 15 illustrates an activated first protection path according to an example embodiment.

A first ODU trail may be transmitted using the first protection path 1420 through activation. Also, an adaptation function performed between two nodes requiring the adaptation function may be described with reference to FIG. 15.

To activate the first protection path 1420, a link between two node included in the first protection path 1420 may need to be activated.

Hereinafter, descriptions about a node for activating a link between two nodes on a protection path will be provided with reference to FIGS. 16 through 19.

Descriptions provided with reference to FIGS. 1 through 14 may be identically applied and thus, repeated descriptions will be omitted for increased clarity and conciseness.

FIG. 16 illustrates a configuration of a node 1600 according to an example embodiment.

The node 1600 may include a communicator 1610, a processor 1620, and a storing unit 1630.

The storing unit 1630 may store information received by the communicator 1610. The storing unit 1630 may store information generated or processed by the processor 1620. The storing unit 1630 may store routing information of the node 1600.

Hereinafter, descriptions about the communicator 1610, the processor 1620, and the storing unit 1630 will be provided with reference to FIGS. 17 through 19.

Descriptions provided with reference to FIGS. 1 through 15 may be identically applied and thus, repeated descriptions will be omitted for increased clarity and conciseness.

FIG. 17 illustrates an example of a signal flow in a link activation method according to an example embodiment.

A first node 1710 may be the node C 1403 of FIG. 14. Thus, the first node 1710 may be an intermediate node.

A second node 1712 may be a node subsequent to the first node 1710 included in a protection path to be activated.

A third node 1714 may be the node A 1401 of FIG. 14. Thus, the third node 1714 may be an ingress node of the protection path.

A fourth node 1716 may be the node K 1405 of FIG. 14. Thus, the fourth node 1716 may be an egress node of the protection path.

Each of the first node 1710, the second node 1712, the third node 1714, and the fourth node 1716 of FIG. 17 may correspond to the node 1600 of FIG. 16.

For example, each of the first node 1710, the second node 1712, the third node 1714, and the fourth node 1716 may be a single instance of the node 1600, and indicate that the node 1600 performs different functions.

Each of a communicator of the first node 1710, a communicator of the second node 1712, a communicator of the third node 1714, and a communicator of the fourth node 1716 may correspond to the communicator 1610 of the node 1600.

In operation 1718, when an error occurs in a main path, a processor of the third node 1714 may determine to use the protection path to transmit an ODU or an ODU trail.

In operation 1720, the communicator of the third node 1714 may transmit, to the first node 1710, a first activation message requesting activation of a first link between the first node 1710 and the second node 1712. The first activation message may have the type of the ODUk frame 600 described above.

The first link between the first node 1710 and the second node 1712 may be a link for transmitting a lower order ODU of the ODU. For example, the lower order ODU may be an ODUj. To distinguish the ODU from the lower order ODU, the ODU may be referred to as a higher order ODU. For example, the higher order ODU may be an ODUk.

The lower order ODU may be generated by multiplexing the higher order ODU. For example, in a case in which the ODUk corresponds to a high order, the ODUj may correspond to a low order of an OTUk multiplexed when the ODUk is multiplexed.

The lower order ODU may include a client signal. For example, a lower order client signal may be a payload of the lower order ODU.

The communicator of the first node 1710 may receive, from the third node 1714, the first activation message requesting activation of the first link between the first node 1710 and the second node 1712 for transmitting the lower order ODU.

In operation 1725, when the first activation message is received, the communicator of the first node 1710 transmit, to the second node 1712, an adaptation request message requesting a first adaptation function be performed between the higher order ODU and the lower order ODU. For example, an adaptation function may be performed by establishing a relationship between a higher order ODU and a lower order ODU such that multiplexing or demultiplexing is performed between the higher order ODU and the lower order ODU.

The communicator of the second node 1712 may receive the adaptation request message from the first mode 1710.

In operation 1730, in response to the adaptation request message, a processor of the second node 1712 may perform the first adaptation function between the higher order ODU and the lower order ODU. By performing the first adaptation function, a bandwidth of the second node for the protection path may be obtained.

In operation 1735, the communicator of the second node 1712 may transmit a response message responding to a request for the first adaptation function. The response message may include adaptation information associated with the first adaptation function. For example, the adaptation information associated with the first adaptation function may be information associated with resources of the second node 1712 for use in the first adaptation function. For example, the information associated with resources may be a PN of a TS.

The communicator of the first node 1710 may receive, from the second node 1712, the response message responding to the request for the first adaptation function.

In operation 1740, a processor of the first node 1710 may perform a second adaptation function between the higher order ODU and the lower order ODU when the first adaptation function is performed.

For example, the processor of the first node 1710 may perform the second adaptation function using resources of the first node 1710 for use in the second adaptation function when the resources are present. A bandwidth of the first node 710 for the protection path may be obtained using the resources.

Descriptions about a method of performing the second adaptation function will be provided with reference to FIG. 18.

In operation 1745, the processor of the first node 1710 may generate a cross connection (XC) between the first node 1710 and the second node 1712 based on the performed first adaptation function and the performed second adaptation function. The processor of the first node 1710 may activate the first link by generating the XC.

In operation 1750, the communicator of the first node 1710 may transmit, to the second node 1712, a second activation message requesting activation of a second link between the second node 1712 and the fourth node 1716 for transmission of the lower order ODU.

The second activation message may have the type of the ODUk frame 600 described above. The second activation message may include adaptation information associated with the performed second adaptation function. The adaptation information may be information associated with resources for use in the second adaptation function. For example, the information associated with resources may be a PN of a PS.

The adaptation information may be indicated in the RES field 730 of the second activation message.

Descriptions about the adaptation information indicated in the RES field 730 will be provided with reference to FIG. 19.

The communicator of the second node 1712 may receive the second activation message from the first node 1710.

In an embodiment, when the communicator received the second activation message from the first node 1710, operations 1725 through 1750 may be re-performed. Re-performing of operations 1725 through 1750 may be explained by substituting the first node 1710 which is a subject performing operations 1725 through 1750, in place of the second node 1712.

In another embodiment, when a subsequent node of the second node 1712 is an egress node, the adaptation function may not be performed on the second node 1712 and the egress node. For example, operations corresponding to operations 1725 through 1745 may not be performed on the second node 1712.

Operations explained subsequent to operation 1750 may be performed when a subsequent node of the second node 1712 is the egress node.

In operation 1755, when the second activation message is received, the processor of the second node 1712 may activate the second link by generating an XC between the second node 1712 and the fourth node 1716. The fourth node 1716 may be the egress node.

In operation 1760, the communicator of the second node 1712 may transmit, to the fourth node 1716, a third activation message requesting generation of an XC between the third node 1714 and the fourth node 1716.

The communicator of the fourth node 1716 may receive the third activation message from the third node 1714.

In operation 1765, when the third activation message is received, a processor of the fourth node 1716 may generate the XC between the third node 1714 and the fourth node 1716.

In operation 1770, the communicator of the fourth node 1716 may transmit, to the third node 1714, a response message in response to the generating of the XC between the third node 1714 and the fourth node 1716.

A protection path between the third node 1714 and the fourth node 1716 may be activated by performing operations 1720 through 1770.

When operations 1720 through 1770 are performed, the lower order ODU may be transmitted through the activated protection path.

Descriptions provided with reference to FIGS. 1 through 16 may be identically applied and thus, repeated descriptions will be omitted for increased clarity and conciseness.

FIG. 18 illustrates a method of performing a second adaptation function according to an example embodiment.

Operation 1740 of FIG. 17 may include operations 1810 through 1840 below.

In operation 1810, the processor of the first node 1710 may determine whether resources of the first node 1710 for use in the second adaptation function are present. For example, the processor of the first node 1710 may determine whether resources not allocated to another path exist among a plurality of resources of the first node 1710. The resources not allocated to another path may be available resources for performing the second adaptation function. When a protection path to be activated has a higher priority than a priority of another path, the resources used for the other path may be used to activate the protection path.

For example, the processor of the first node 1710 may determine whether resources of the first node 1710 for use in the second adaptation function are present based on profile information set to the first node 1710.

Profile information associated with the node C 1403 of FIG. 14 may be indicated in Table 3.

TABLE 3

| | | | | | | Tributary |
|---|---|---|---|---|---|---|
| | | | | | | Slot |
| Con- | | | | Connec- | | Port |
| nection | Path | | Output | tion | | Number |
| port | identifier | Path state | port | state | Priority | (TSPN) |
| C1 | First | Inter- | C2 | Connect- | 1 | 1-8 |
| | subpath | mediate | | ed | | |
| C2 | First | Inter- | C1 | Connect- | 1 | 1-8 |
| | subpath | mediate | | ed | | |
| C3 | Second | Inter- | C2 | Dis- | 2 | 9-16 |
| | subpath | mediate | | connect- | | |
| | | | | ed | | |
| C2 | Second | Inter- | C3 | Dis- | 3 | 9-16 |
| | subpath | mediate | | connect- | | |
| | | | | ed | | |

In Table 3, the connection port may be a port of the node C 1403, which is connected to a link between the node C 1403 and a preceding node of the node C 1403. For example, one or more ports of the node C 1403 may include C1, C2, and C3.

The path identifier may be an identifier indicating a path including the node C 1403. For example, the path identifier may be expressed alphanumerically.

The path state may indicate whether the node C 1403 is an intermediate node of a path or an egress node of the path. For example, when the node C 1403 is the intermediate node of the path, the path state may correspond to “intermediate”. When the node C 1403 is the egress node of the path, the path state may correspond to “exit” or “end”.

The output port may be a port of the node C 1403, which is connected to a link between the node C 1403 and a subsequent node of the node C 1403.

The connection state may indicate an activated path among paths including the node C 1403.

The priority may be a priority of a path activated to the node C 1403.

The TSPN may indicate a TSPN of the node C 1403, which is used in a lower order

ODU when the output port of the node C 1403 is used as a server of a higher order ODU. For example, when a TSPN of a path corresponds to “1” through “8”, a lower order ODU of the path may use one of ports 1 through 8.

When the resources are determined to be present, operation 1820 may be performed. When the resources are determined to be absent, for example, when the second adaptation function is not performed, operation 1850 may be performed.

In operation 1820, when the resources are present, the processor of the first node 1710 may determine whether the resources are predetermined resources for use in an adaptation function between the higher order ODU and the lower order ODU. For example, the processor of the first node 1710 may determine whether the resources are predetermined resources for the protection path by verifying adaptation information associated with the first node 1710. The adaptation information may be information associated with an adaptation function performed in the first node 1710.

In operation 1830, when the resources are the predetermined resources, the processor of the first node 1710 may perform the second adaptation function between the higher order ODU and the lower order ODU based on information associated with the predetermined resources. For example, the information associated with the predetermined resources may be information associated with a TS indicating the predetermined resources.

In operation 1750, the second activation message transmitted to the second node 1712 may include the information associated with the predetermined resources.

The information associated with the predetermined resources may be indicated in the APS and PCC field 720 of the second activation message.

In operation 1840, when the resources are not the predetermined resources, the processor of the first node 1710 may perform the second adaptation function between the higher order ODU and the lower order ODU based on information associated with the resources. For example, the information associated with the resources may be information associated with a TS indicating the resources.

In operation 1750, the second activation message transmitted to the second node 1712 may include information associated with the resources used for the second adaptation function.

The information associated with the resources used for the second adaptation function may be indicated in the APS and PCC field 720 of the second activation message.

In operation 1850, when the resources of the first node 1710 for use in the second adaptation function are absent, the communicator of the first node 1710 may transmit, to the third node 1714, a failure message indicating a failure in activating the first link. For example, when the second adaptation function is not performed, the communicator of the first node 1710 may transmit, to the third node 1714, the failure message indicating the failure in activating the first link.

Descriptions provided with reference to FIGS. 1 through 17 may be identically applied and thus, repeated descriptions will be omitted for increased clarity and conciseness.

FIG. 19 illustrates a revised reserved field according to an example embodiment.

The RES field 730 of FIG. 7 may include information associated with a second adaptation function. The information associated with the second adaptation function may include at least one of a content of a request from the first node 1710, a type of an interface set to the first node 1710, a PN of a TS used for the second adaptation function, and an ODU trail identifier.

The RES field 730 may include a request (Req) field 1910 indicating a form of a request, a T field 1910 indicating a type of an interface, a tributary slot port (TSP) field 1930, and an ODU trail identifier field 1940 indicating an ODU trail identifier.

The Req field 1910 may indicate content of a request from the first node 1710 to the second node 1712, or content of a response of the first node 1710.

The T field 1920 may indicate a type of an interface set to the first node 1710. The type of the interface set to the first node 1710 may be one of I-NNI types. For example, the T field 1920 may indicate whether the type of the interface set to the first node 1710 is a type of an interface accepting ODU multiplexing of at least two levels of data. Thus, the T field 1920 may indicate whether the type of the interface set to the first node 1710 is an I-NNI type-3.

The TSP field 1930 may indicate information associated with resources for use in the second adaptation function among resources of the first node 1710. For example, the information associated with the resources may be a PN of a TS. The PN of the TS may be used to be a connection point of the first node 1710 of a first link.

The ODU trail identifier field 1940 may indicate an identifier to identify a protection path to be activated among a plurality of paths set on a network.

Based on the RES field 730, profile information of a node may be dynamically configured during an operation of the node without a network operator being set in advance.

Descriptions provided with reference to FIGS. 1 through 18 may be identically applied and thus, repeated descriptions will be omitted for increased clarity and conciseness.

According to an aspect of the present invention, it is possible to provide a method and apparatus for activating a link between two nodes.

According to another aspect of the present invention, it is possible to provide a link activation method and apparatus for a protection node.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A link activation method performed by a first node, the method comprising:
receiving, from a third node, a first activation message requesting activation of a first link between the first node and a second node for transmission of a lower order optical channel data unit (ODU);
transmitting, in response to the first activation message, to the second node, an adaptation request message requesting a first adaptation function be performed between a higher order ODU and the lower order ODU;
receiving, from the second node, a response message responding to a request for the to first adaptation function;
performing, when the first adaptation function is performed, a second adaptation function between the higher order ODU and the lower order ODU; and
activating the first link by generating a cross connection (XC) between the first node and the second node based on the first adaptation function and the second adaptation function.

2. The method of claim 1, further comprising:
transmitting, to the second node, a second activation message requesting activation of a second link between the second node and a fourth node for transmission of the lower order ODU.

3. The method of claim 1, wherein the performing comprises determining whether resources of the first node for use in the second adaptation function are present, and
performing the second adaptation function using the resources of the first node for use in the second adaptation function when the resources are determined to be present.

4. The method of claim 3, wherein the performing further comprises determining whether the resources are predetermined resources for use in an adaptation function between the higher order ODU and the lower order ODU, and
performing the second adaptation function between the higher order ODU and the lower order ODU based on information associated with the predetermined resources when the resources are the predetermined resources.

5. The method of claim 4, further comprising:
transmitting, to the second node, a second activation message requesting activation of a second link between the second node and a fourth node for transmission of the lower order ODU,
wherein the second activation message comprises the information associated with the predetermined resources.

6. The method of claim 5, wherein the information of the predetermined resources is indicated in an automatic protection switching coordination channel and protection communication control channel (APS and PCC) field of the second activation message.

7. The method of claim 3, wherein the performing further comprises determining whether the resources are predetermined resources for use in an adaptation function between the higher order ODU and the lower order ODU, and
performing, when the resources are not the predetermined resources, the second adaptation function between the higher order ODU and the lower order ODU based on information associated with the resources.

8. The method of claim 7, further comprising:
transmitting, to the second node, a second activation message requesting activation of a second link between the second node and a fourth node for transmission of the lower order ODU,
wherein the second activation message comprises the information associated with the second activation message.

9. The method of claim 8, wherein the information associated with the resources is indicated in an APS and PCC field of the second activation message.

10. The method of claim 1, further comprising:
transmitting a failure message indicating a failure in activating the first link to the third node when the second adaptation function is not performed.

11. The method of claim 1, further comprising:
transmitting, to the second node, a second activation message requesting activation of a second link between the second node and a fourth node for use in transmission of the lower order ODU,
wherein the second activation message comprises adaptation information of the performed second adaptation function.

12. The method of claim 11, wherein the adaptation information is indicated in a reserved field of the second activation message.

13. The method of claim 11, wherein the information associated with the second adaptation function comprises at least one of content of a request from the first node, a type of an interface set to the first node, a port number (PN) of a tributary slot (TS) for use in the second adaptation function, and an ODU trail identifier.

14. The method of claim 13, wherein the type of the interface set to the first node corresponds to one of internal-network to network interface (I-NNI) types.

15. The method of claim 11, wherein the information associated with the second adaptation function comprises a type of an interface set to the first node, and indicates whether the interface has a type accepting ODU multiplexing of at least two levels of data.

16. A node comprising, the node being a first node:
a communicator to receive, from a third node, a first activation message requesting activation of a first link between the first node and a second node for transmission of a lower order optical channel data unit (ODU), transmit, to the second node, in response to the first activation message, an adaptation request message requesting a first adaptation function be performed between a higher order ODU and the lower order ODU, and receive, from the second node, a response message responding to a request for the first adaptation function; and
a processor to perform, when the first adaptation function is performed, a second adaptation function between the higher order ODU and the lower order ODU, and activate the first link by generating a cross connection (XC) between the first node and the second node based on the first adaptation function and the second adaptation function.

17. The node of claim 16, wherein the communicator transmits, to the second node, a second activation message requesting activation of a second link between the second node and a fourth node for transmission of the lower order ODU.

18. The node of claim 16, wherein the processor determines whether resources of the first node for use in the second adaptation function are present, and performs the second adaptation function using the resources of the first node for use in the second adaptation function when the resources are determined to be present.

19. The node of claim 16, wherein the communicator transmits, to the second node, a second activation message requesting activation of a second link between the second node and a fourth node for transmission of the lower order ODU, and
wherein the second activation message comprises the information associated with the performed second adaptation function.
